(19) United States
(12) Patent Application Publication
(10) Pub. No.: US 2008/0232810 A1
(43) Pub. Date: Sep. 25, 2008

(54) BLUETOOTH-ENABLED INFRARED REMOTE CONTROL

(75) Inventors: Ming-Huei Lu, Taipei County (TW); Chu-Chai Hong, Taipei County (TW)

Correspondence Address: WPAT, PC, 7225 BEVERLY ST., ANNANDALE, VA, 22003, US

(73) Assignee: HALFA ENTERPRISE CO., LTD., Taipei County (TW)

(21) Appl. No.: 11/877,776

(22) Filed: Oct. 24, 2007

(30) Foreign Application Priority Data
Mar. 19, 2007 (TW) 096204355

(51) Int. Cl. H04B 10/00

(52) U.S. Cl. 398/112

(57) ABSTRACT

A Bluetooth-enabled infrared (IR) remote control is disclosed, which comprises: a micro control unit, for executing operations of signal processing, decoding and encoding; an signal amplifying circuit, for amplifying a control signal being issued and coded by the micro control unit to be used for controlling a corresponding function of a specific electronic device; an infrared light emitting diode (IRLED), capable of issuing an infrared signal; and a Bluetooth module, capable of communicating with a bluetooth-enabled electronic device by Bluetooth wireless transmission while passing data received from the bluetooth-enabled electronic device to the micro control unit where it is processed.

### FIELD OF THE INVENTION

The present invention relates to a Bluetooth-enabled remote control, and more particularly, to an infrared (IR) remote control having a Bluetooth module integrated therein for enabling the IR remote control to communicate with a plurality of Bluetooth-enabled electronic devices and thus controlling the same. With the aforesaid mechanism, the Bluetooth-enabled IR remote control is capable of acting as an universal remote control that is not limited to control operations of a specified electronic device, but is able to pair with any Bluetooth-enabled electronic device under instructions of a user for enabling the user to control operations of the paired Bluetooth-enabled electronic device within a specific working range by Bluetooth wireless transmission technology, so that the flexibility and mobility of the IR remote control are facilitated as there is no dead angle as well as no obstacles capable of blocking the IR remote control.

### BACKGROUND OF THE INVENTION

We live in a complicated age, and nowhere exemplifies this more than our living room where is filled with remote controls for various electronic appliances, ranging from TVs, DVD players to set-top boxes and even dusty old VCRs. Controlling all of this is always a bit of a challenge since it is difficult to sift though a sea of remote controls just to pick up the one paired with the appliance intended to be controlled. Although there are products, such as IR universal remote controls, capable of being used for controlling multiple appliances, such universal remote control can only function within a specific closed space since the infrared ray transmission can be blocked by dead angle and obstacles. It is intended therefore to provide a remote control capable of controlling multiple appliances by the use of Bluetooth wireless transmission technology so that the remote control can be free from the aforesaid space limitation.

### SUMMARY OF THE INVENTION

In view of the disadvantages of prior art, the primary object of the present invention is to provide an infrared (IR) remote control having a Bluetooth module integrated therein for enabling the IR remote control to communicate with a plurality of Bluetooth-enabled electronic devices and thus controlling the same. With the aforesaid mechanism, the Bluetooth-enabled IR remote control is capable of acting as an universal remote control that is not limited to control operations of a specified electronic device, but is able to pair with any Bluetooth-enabled electronic device under instructions of a user for enabling the user to control operations of the paired Bluetooth-enabled electronic device within a specific working range by Bluetooth wireless transmission technology, so that the flexibility and mobility of the IR remote control are facilitated as there is no dead angle as well as no obstacles capable of blocking the IR remote control.

Another object of the invention is to provide a Bluetooth-enabled IR remote control being configured with a plurality of infrared light emitting diodes (IRLEDs), by which any IR signal of the remote control, issued by a micro control unit and then after being amplified by a signal amplifying circuit, is emitted by at least two of the plural IRLEDs for enabling the IR signal to be emitted in a manner that it can cover a vast range and thus enabling the remote control to have a comparatively larger angle of signal coverage.

In a first exemplary embodiment of the invention, the present invention provides a Bluetooth-enabled IR remote control, which is comprised of:
a micro control unit, for executing operations of signal processing, decoding and encoding;
an signal amplifying circuit, for amplifying a control signal being issued and coded by the micro control unit to be used for controlling a corresponding function of a specific electronic device;
an infrared light emitting diode (IRLED), capable of issuing an infrared signal; and
a Bluetooth module, capable of communicating with a bluetooth-enabled electronic device by Bluetooth wireless transmission while passing data received from the bluetooth-enabled electronic device to the micro control unit where it is processed.

In a second exemplary embodiment of the invention, the present invention provides a Bluetooth-enabled IR remote control, which is comprised of:
a micro control unit, for executing operations of signal processing, decoding and encoding;
a plurality of infrared light emitting diodes, for emitting infrared (IR) signals;
a plurality of photodiodes, for receiving infrared (IR) signals;
a first signal amplifying circuit, for amplifying a control signal being issued and coded by the micro control unit to be used for controlling a corresponding function of a specific electronic device;
a second signal amplifying circuit, for amplifying the IR signals received from the photodiodes to be used for establishing a new coding in the remote control and thus enabling the micro control unit to issue control signals capable of controlling an electronic device issuing the aforesaid IR signals;
a Bluetooth module, capable of communicating with a bluetooth-enabled electronic device by Bluetooth wireless transmission while passing data received from the bluetooth-enabled electronic device to the micro control unit where it is processed; and
a storage unit, for storing the new coding of the electronic device with respect to the IR signals received by the photodiodes.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a Bluetooth-enabled IR remote control according to a first exemplary embodiment of the invention.

FIG. 2 shows another Bluetooth-enabled IR remote control according to a second exemplary embodiment of the invention.

FIG. 3 is a schematic diagram depicting the use of a Bluetooth-enabled IR remote control of the invention for remotely controlling a plurality of electronic devices.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

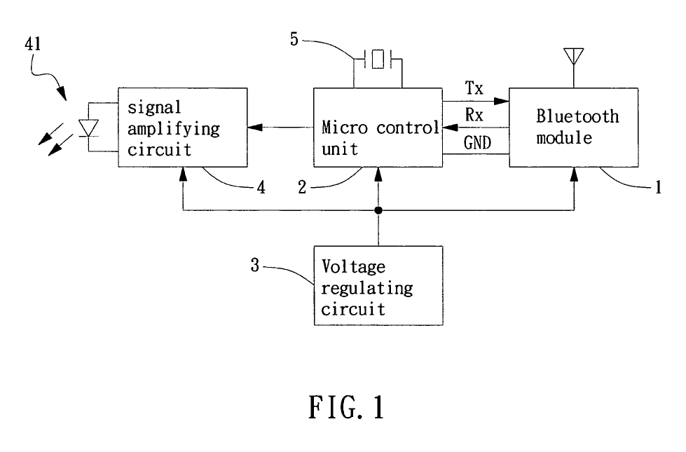

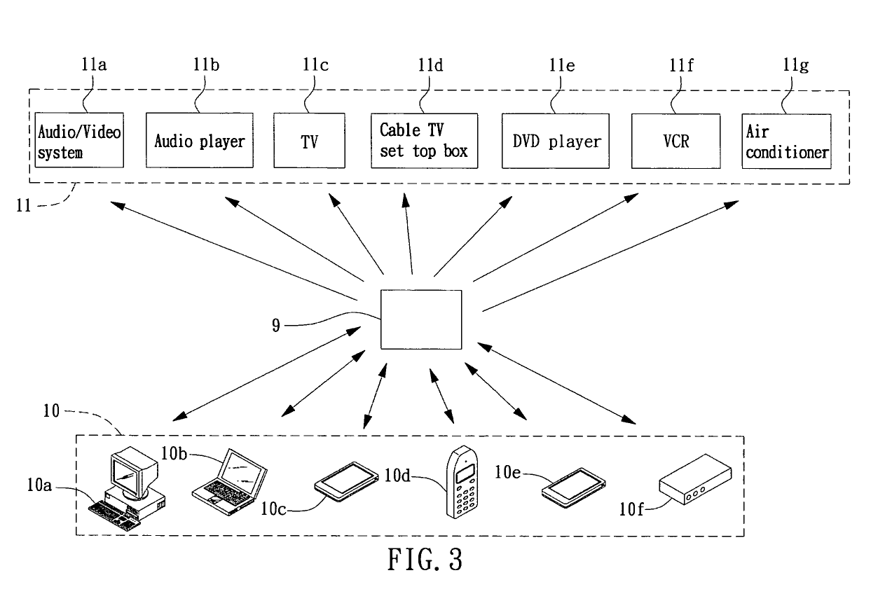

Please refer to FIG. 1, which shows a Bluetooth-enabled IR remote control according to a first exemplary embodiment of the invention. In FIG. 1, the Bluetooth-enabled IR remote control is comprised of: an infrared light emitting diode (IRLED) 41, a signal amplifying circuit 4, a micro control unit (MCU) 2, a voltage regulating circuit 3, a Bluetooth module 1. The transmission of the Bluetooth module 1 is defined by the serial port profile (SPP) so that it can communicate with other Bluetooth-enabled electronic device for Bluetooth wireless transmission while passing data received from the bluetooth-enabled electronic device to the micro control unit where it is processed. Please refer to FIG. 3, which is a schematic diagram depicting the use of a Bluetooth-enabled IR remote control of the invention for remotely controlling a plurality of electronic devices. As seen in FIG. 3, the bluetooth-enabled electronic devices 10 capable of being controlled by the aforesaid Bluetooth-enabled IR remote control 9 includes: a desktop personal computer (PC) 10a, a notebook computer (NB) 10b, a personal digital assistant (PDA) 10c, a mobile phone 12d, a smart phone 10e and a set top box 10f. In addition, he set top box 10f is capable of receiving signals transmitting from a network selected from the group consisting of a local area network (LAN), a broadband network including asymmetric digital subscriber line (ADSL) and cable, a public switched telephone network (PSTN) and a lease line. In a preferred aspect, a control code database is established in the micro control unit so that each control code of the database is capable of being used for coding the control signal of the micro control unit to be used for controlling a corresponding function of an electronic device defined by the control code, and the control database can be stored in a storage unit. It is noted that the storage unit can be a built-in unit embedded inside the micro control unit 2, or can be external unit connected to the external circuit of the micro control unit 2. As shown in FIG. 1, the micro control unit is further connected to an oscillator 5, which is made of quartz and used for generating working pulses for the IR remote control. As the output legs of the micro control unit 2 are connected to the signal amplifying circuit 4, the signal amplifying circuit 4 is capable of amplifying a control signal being issued and coded by the micro control unit 2 to be used for controlling a corresponding function of a specific electronic device 11. Preferably, the specific electronic device 11 can be an audio/video system 11a, an audio player 11b (such as MP3 player or MP4 player), a TV 11c, a cable TV 11d, a DVD player 11e, a video cassette recorder (VCR) 11f, an air conditioner 11g, and other devices with IR signal receiving ability. It is noted that any other newly developed electronic devices that are not available right now are not to be regarded as not included in the spirit and scope of the invention, only if they are configured with IR signal receiving ability. The Bluetooth-enabled IR remote control is capable of acting as an universal remote control that is able to send a control signal form the IRLED to the IR receiver of a selected electronic device 11 under instructions of a user for enabling the user to control operations of the selected electronic device 11. As shown in FIG. 1, all the signal amplifying circuit 4, the micro control unit 2, and the Bluetooth module 1 are connected to the voltage regulating circuit 3 by an end thereof for providing DC voltage boost, buck and stabilizing functions to the signal amplifying circuit 4, the micro control unit 2, and the Bluetooth module 1. It is noted that the voltage regulating circuit 3 is capable of receiving power from a device selected from a group consisting of a battery and a transformer.

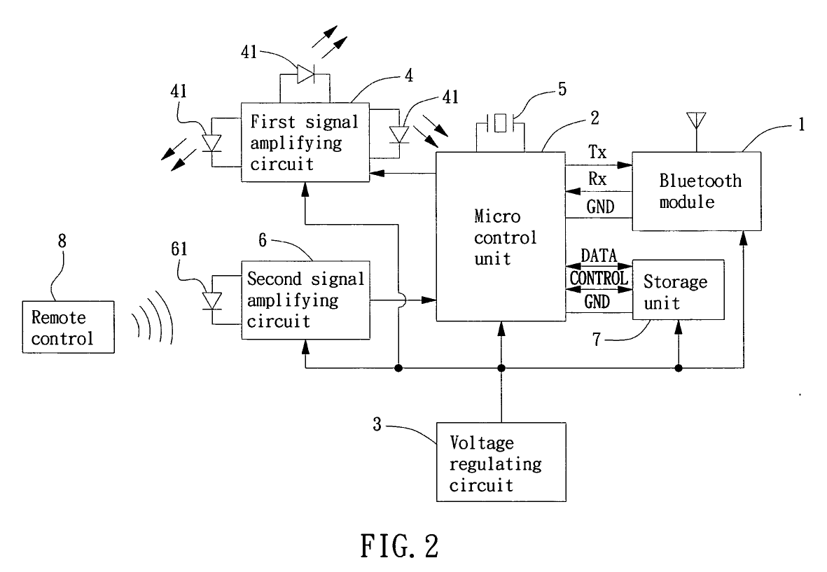

Please refer to FIG. 2, which shows another Bluetooth-enabled IR remote control according to a second exemplary embodiment of the invention. In FIG. 2, the Bluetooth-enabled IR remote control is comprised of: a plurality of IRLEDs 41, a photodiode 61, a first signal amplifying circuit 4, a second signal amplifying circuit 6, a MCU 2, a voltage regulating circuit 3, a Bluetooth module 1, and a storage unit 6. In this second embodiment of the invention, there is only three IRLED 41 being configured in the Bluetooth-enabled IR remote control that are used for emitting IR signals, however, the number of the IRLED is not limited thereby. It is known that if an IR signals of the Bluetooth-enabled IR remote control, issued by the micro control unit 2 and then after being amplified by the first signal amplifying circuit 4, is emitted by at least two of the plural IRLEDs 41, the IR signal can be emitted in a manner that it can cover a vast range and thus enabling the remote control to have a comparatively larger angle of signal coverage. For example, when there are three IRLEDs being equiangularly spaced by 120 degrees, or there are four IRLEDs being equiangularly spaced by 90 degrees, or there are six IRLEDs being equiangularly spaced by 60 degrees, the signal coverage of the resulting IR remote control is comparatively larger than that with only one IRLED.

Moreover, in the second exemplary embodiment, a photodiode 61 and a second signal amplifying circuit 6 are configured in the Bluetooth-enabled IR remote control, by which the Bluetooth-enabled IR remote control is equipped with a learning ability. That is, if the control code of a new electronic device is not already established in the MCU 2, it is intended by a user to align the original remote control of the new electronic device with the photodiode 60 of the Bluetooth-enabled IR remote control and then enable the original remote control to send an IR signal to be received by the photodiode 61, whereas the received IR signal, being amplified by the second signal amplifying circuit 6 and decoded/processed by the MCU 2, is converted into a control code defining the new electronic device that is transmitted to the storage unit 7 where it is stored. Thereby, the control code defining the new electronic device is established in the MCU 2 so as to be used for controlling the same. Preferably, the storage unit is a device selected from the group consisting of an electrically erasable programmable read-only memory (EEPROM), a static random access memory (SRAM), a flash memory, a memory card, and a hard disk drive. Similarly, all the first signal amplifying circuit 4, the second signal amplifying circuit 6, the storage unit 7, the micro control unit 2, and the Bluetooth module 1 are connected to the voltage regulating circuit 3 by an end thereof for providing DC voltage boost, buck and stabilizing functions to the signal amplifying circuit 4, the micro control unit 2, and the Bluetooth module 1. It is noted that the voltage regulating circuit 3 is capable of receiving power from a device selected from a group consisting of a battery and a transformer.

To sum up, the present invention provides a Bluetooth-enabled remote control, and more particularly, to an infrared (IR) remote control having a Bluetooth module integrated therein for enabling the IR remote control to communicate with a plurality of Bluetooth-enabled electronic devices and thus controlling the same. With the aforesaid mechanism, the Bluetooth-enabled IR remote control is capable of acting as an universal remote control that is not limited to control operations of a specified electronic device, but is able to pair with any Bluetooth-enabled electronic device under instructions of a user for enabling the user to control operations of the paired Bluetooth-enabled electronic device within a specific working range by Bluetooth wireless transmission technology, so that the flexibility and mobility of the IR remote control are facilitated as there is no dead angle as well as no obstacles capable of blocking the IR remote control.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Bluetooth-enabled infrared (IR) remote control, comprising:
a micro control unit, for executing operations of signal processing, decoding and encoding;
an signal amplifying circuit, for amplifying a control signal being issued and coded by the micro control unit to be used for controlling a corresponding function of a specific electronic device;
an infrared light emitting diode (IRLED), capable of issuing an infrared signal; and
a Bluetooth module, capable of communicating with a bluetooth-enabled electronic device by Bluetooth wireless transmission while passing data received from the bluetooth-enabled electronic device to the micro control unit where it is processed.

2. The Bluetooth-enabled IR remote control of claim 1, further comprising a voltage regulating circuit.

3. The Bluetooth-enabled IR remote control of claim 2, wherein the voltage regulating circuit is capable of receiving power from a device selected from a group consisting of a battery and a transformer.

4. The Bluetooth-enabled IR remote control of claim 1, wherein the micro control unit is connected to an oscillator.

5. The Bluetooth-enabled IR remote control of claim 4, wherein the oscillator is made of quartz.

6. The Bluetooth-enabled IR remote control of claim 1, wherein a control code database is established in the micro control unit and each control code of the database is capable of being used for coding the control signal of the micro control unit to be used for controlling a corresponding function of an electronic device defined by the control code.

7. The Bluetooth-enabled IR remote control of claim 1, wherein the electronic device is a device selected from the group consisting of a video/audio system, an audio player, a television (TV), a cable TV, a DVD player, a video cassette recorder (VCR), an air conditioner, and other devices with IR signal receiving ability.

8. The Bluetooth-enabled IR remote control of claim 1, wherein the bluetooth-enabled electronic device is a device selected from the group consisting of a desktop personal computer, a notebook computer, a personal digital assistant (PDA), a mobile phone, a smart phone and a set top box.

9. The Bluetooth-enabled IR remote control of claim 8, wherein the set top box is capable of receiving signals transmitting from a network selected from the group consisting of a local area network (LAN), a broadband network including asymmetric digital subscriber line (ADSL) and cable, a public switched telephone network (PSTN) and a lease line.

10. A Bluetooth-enabled infrared (IR) remote control, comprising:
a micro control unit, for executing operations of signal processing, decoding and encoding;
a plurality of infrared light emitting diodes, for emitting infrared (IR) signals;
a plurality of photodiodes, for receiving infrared (IR) signals;
a first signal amplifying circuit, for amplifying a control signal being issued and coded by the micro control unit to be used for controlling a corresponding function of a specific electronic device;
a second signal amplifying circuit, for amplifying the IR signals received from the photodiodes to be used for establishing a new coding in the remote control and thus enabling the micro control unit to issue control signals capable of controlling an electronic device issuing the aforesaid IR signals;
a Bluetooth module, capable of communicating with a bluetooth-enabled electronic device by Bluetooth wireless transmission while passing data received from the bluetooth-enabled electronic device to the micro control unit where it is processed; and
a storage unit, for storing the new coding of the electronic device with respect to the IR signals received by the photodiodes.

11. The Bluetooth-enabled IR remote control of claim 10, further comprising a voltage regulating circuit.

12. The Bluetooth-enabled IR remote control of claim 11, wherein the voltage regulating circuit is capable of receiving power from a device selected from a group consisting of a battery and a transformer.

13. The Bluetooth-enabled IR remote control of claim 10, wherein the micro control unit is connected to an oscillator.

14. The Bluetooth-enabled IR remote control of claim 13, wherein the oscillator is made of quartz.

15. The Bluetooth-enabled IR remote control of claim 10, wherein a control code database is established in the micro control unit and each control code of the database is capable of being used for coding the control signal of the micro control unit to be used for controlling a corresponding function of an electronic device defined by the control code.

16. The Bluetooth-enabled IR remote control of claim 10, wherein the electronic device is a device selected from the group consisting of a video/audio system, an audio player, a television (TV), a cable TV, a DVD player, a video cassette recorder (VCR), an air conditioner, and other devices with IR signal receiving ability.

17. The Bluetooth-enabled IR remote control of claim 10, wherein the bluetooth-enabled electronic device is a device selected from the group consisting of a desktop personal computer, a notebook computer, a personal digital assistant (PDA), a mobile phone, a smart phone and a set top box.

18. The Bluetooth-enabled IR remote control of claim 16, wherein the set top box is capable of receiving signals transmitting from a network selected from the group consisting of a local area network (LAN), a broadband network including asymmetric digital subscriber line (ADSL) and cable, a public switched telephone network (PSTN) and a lease line.

19. The Bluetooth-enabled IR remote control of claim 10, wherein the storage unit is a device selected from the group consisting of an electrically erasable programmable read-only memory (EEPROM), a static random access memory (SRAM), a flash memory, a memory card, and a hard disk drive.
